(19) United States
(12) Patent Application Publication
(10) Pub. No.: US 2008/0086307 A1
(43) Pub. Date: Apr. 10, 2008

(54) Digital contents version management system

(75) Inventors: Nobuya Okayama, Yokohama (JP); Osamu Hoshino, Yokohama (JP); Shigeru Iida, Tokyo (JP); Akiko Isono, Tokyo (JP); Aya Onoyama, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi Consulting Co., Ltd., Tokyo (JP)

(21) Appl. No.: 11/807,698

(22) Filed: May 29, 2007

(30) Foreign Application Priority Data
Oct. 5, 2006 (JP) 2006-273565

(51) Int. Cl. G10L 13/00

(52) U.S. Cl. 704/260; 704/E13.001

(57) ABSTRACT

Preparation of Braille books and audio books by man has a problem that a great deal of costs including the work cost for recitation or translation (printing) of Braille, composition, examination and the like and the distribution cost are required as compared with general books. Further, there is a problem that books that visually handicapped people wish to read cannot be delivered immediately at an inexpensive price. The user (reader) himself participates in editing or correction in processing for producing an audio book which reads an electronic book aloud using the speech synthesis technique and pronunciation symbol text constituting the basis of the audio book to thereby reduce the cost required for the production processing of the audio book and the pronunciation symbol text and improve the quality of the audio book and the pronunciation symbol text.

### INCORPORATION BY REFERENCE

The present application claims priority from Japanese application JP2006-273565 filed on Oct. 5, 2006, the content of which is hereby incorporated by reference into this application.

### BACKGROUND OF THE INVENTION

The present invention relates to technique for supporting the provision of audio books utilizing the speech synthesis technique and more particularly to technique for managing of the versions of the audio books.

With the development of communication such as the Internet and mobile information terminals, distribution and sale of digital contents are activated. The market of electronic books in delivery and business of the digital contents is growing with the increase of electronic books for portable telephones (hereinafter referred to as KEITAI books (books for mobile)). With the growth of such a market, publishers having the system for electronically making publication are also increased and the market of the electronic books can be expected to be activated increasingly.

A lot of people expect the universal design publication (hereinafter referred to as UD publication) in the growth of the electronic book market. There are many people who cannot read publications although they want to read in the world. They are visually handicapped people and old people having remarkably poor eyesight. According to the investigation of the Ministry of Welfare and Labor of Japan, in the statistical information in 2001, the total number of visually handicapped people is 301,000 persons including 47.8% (144,000 persons) being under 70 years of age and 51.5% (155,000 persons) being 70 years of age or over. In order to have such many visually handicapped people read more books, there is a method of preparing books utilizing Braille (hereinafter referred to as Braille books) or audio books to support reading. A large number of people are required to prepare the Braille books or the audio books. In the actual situation, citizen volunteers or staffs of the Non-Profit Organization (NPO) support it currently and the number of persons who can support handicapped people is still smaller.

As a technique for supporting visually handicapped people, there is disclosed “Information Access System and Recording Medium” (JP-A-7-152787). The technique is characterized in that character input information for printing a publication is converted into two-dimensional code symbols of multi-stage type or matrix type to print character information for healthy normal people and the two-dimensional code symbols in parallel, so that the visually handicapped people can acquire the same information as that of the healthy normal person simultaneously.

As another technique for supporting visually handicapped people, there is disclosed “Document Information Input/Output System for Visually Handicapped People” (JP-A-8-106248). The technique has an object to provide a book system easy for visually handicapped people to utilize and is characterized in that at least pronunciation symbol information containing phoneme information and rhythm information is stored in a book database as data of publication and a center system transmits the pronunciation symbol information stored in the book database, so that a publication is recited by the speech synthesis on the basis of the transmitted pronunciation symbol information.

At the current stage, there exist the technique for supporting visually handicapped people by adding “supplementary” information to currently existing data and the technique for supporting such people by using data attributive to predetermined publications (contents), although even if such techniques are used, the required cost cannot be reduced and conversely the cost is increased. That is, there is no technique for preparing contents utilizable by visually handicapped people at a suppressed cost while keeping the quality.

As a technique for improving the quality of contents, there are disclosed “technique concerning estimation of contents using plural persons' comments (reviews)” (http://www.amazon.co.jp) and “technique concerning the promotion of utilization of contents using comments” (JP-A-2002-99739). However, the method of improving the quality of audio books prepared using the speech synthesis at a suppressed cost is not disclosed clearly in the prior art.

As a technique related to the above techniques, there is disclosed “technique for allowing cooperatively editing work to be done without consciousness of place and time in order to edit contents (publications)” (JP-A-2002-41506). This inventive technique is to edit publications among plural persons.

### SUMMARY OF THE INVENTION

Generally, preparation of the Braille books and the audio books by man has a problem that a great deal of costs including the work cost for recitation or translation (printing) of Braille, composition, examination and the like and the distribution cost are required as compared with general books. Further, in production of audio books using the speech synthesis that can be automatized, there are a lot of points to be corrected such as misreading and wrong intonation and in spite of advanced technique there is a problem that the work cost for correction and re-editing is taken in order to attain the quality felt as if a person made recitation. Accordingly, there is a problem that books that visually handicapped people wish to read cannot be delivered immediately at an inexpensive price. The word “cost” in the present invention means time, fund, talent, resource (material) and the like.

It is an object of the present invention to provide a digital contents version management system which can get visually handicapped people or old people having remarkably poor eyesight enjoyed reading easily at the same price as that of healthy normal people.

It is another object of the present invention to provide a digital contents version management system which reduces costs of audio books which read electronic books aloud using the speech synthesis technique, processing costs for producing text describing instructions for controlling accent, intonation, length of sound and the like for pronunciation symbols (hiragana or Japanese cursive kana characters and katakana or square form of kana) constituting the basis of the audio books (hereinafter referred to as pronunciation symbol text) and distribution cost thereof and improves the quality of the audio books while suppressing the costs.

According to the present invention, the digital contents version management system includes a contents management device to transmit data of pronunciation symbol text constituting the basis for reproducing voice by means of speech synthesis, a first terminal device to transmit correction request for the pronunciation symbol text data to the contents management device and a second terminal device utilized to correct the pronunciation symbol text data to transmit the corrected pronunciation symbol text data to the contents management device. The pronunciation symbol text data and a user having a right to utilize the pronunciation symbol text data are made correspond to each other and the correction request for the pronunciation symbol text data stored in the memory is received from the first terminal device. When voice data corrected in accordance with the received correction request is received from the second terminal device, a processing unit stores the corrected voice data and information concerning a right to utilize the corrected voice data into the memory in a corresponding manner to a user of the first terminal device.

Further, according to the present invention, there can provide a measure for allowing users to participate in preparation of the audio books or the pronunciation symbol text.

### BRIEF DESCRIPTION OF THE DRAWINGS

FIG. 1 is a schematic diagram illustrating a digital contents version management system according to an embodiment of the present invention;

FIG. 2 is a schematic diagram illustrating a contents management device 110 of the embodiment;

FIG. 3 is a schematic diagram illustrating a certificate authority management device 120 of the embodiment;

FIG. 4 is a schematic diagram illustrating a terminal device P 130 of the embodiment;

FIG. 5 is a schematic diagram illustrating a terminal device E 140 of the embodiment;

FIG. 6 is a schematic diagram illustrating a terminal device U 150 of the embodiment;

FIG. 7 is a flow chart showing a processing procedure of individual authentication among the contents management device 110, the terminal device P 130, the terminal device E 140 and the terminal device U 150 of the embodiment;

FIG. 8 is a flow chart showing a processing procedure of registering contents itself and attribute information thereof into the contents management device 110 between the contents management device 110 and the terminal device P 130 of the embodiment;

FIG. 9 is a flow chart showing a processing procedure of registering the editing right of the contents itself between the contents management device 110 and the terminal device E 140 of the embodiment;

FIG. 10 is a flow chart showing a processing procedure of correcting and approving the pronunciation symbol text produced from the contents among the contents management device 110, the terminal device P 130 and the terminal device E 140 of the embodiment;

FIG. 11 is a flow chart showing a processing procedure of purchasing the contents between the contents management device 110 and the terminal device U 150 of the embodiment;

FIG. 12 is a flow chart showing a processing procedure of down-loading the purchased contents between the contents management device 110 and the terminal device U 150 of the embodiment;

FIG. 13 is a flow chart showing a processing procedure of updating versions of contents, comment (correction request) on pronunciation symbol text produced from the contents, response to the comment and license among the contents management device 110, the terminal device U 130 and the terminal device E 140 of the embodiment;

FIG. 14 is a flow chart showing a processing procedure of estimating user and editor to the comment (correction request) among the contents management device 110, the terminal device P 130 and the terminal device E 140 or U 150 of the embodiment;

FIG. 15 shows an example of a data table for managing the comment (correction request) in the embodiment; and

FIG. 16 shows an example of a data table for managing points obtained by users in the embodiment.

### DESCRIPTION OF THE EMBODIMENTS

A digital contents version management system according to an embodiment of the present invention is now described.

### Embodiment 1

An outline of the embodiment is first given.

In the embodiment, the user (reader) himself participates in editing or correction in processing for producing an audio book which reads an electronic book aloud using the speech synthesis technique and pronunciation symbol text constituting the basis of the audio book to thereby reduce the cost required for the production processing of the audio book and the pronunciation symbol text and improve the quality of the audio book and the pronunciation symbol text.

In the embodiment, preparatorily, in a portal site of the digital contents version management system, the user (speech synthesis editor) who makes editing using the speech synthesis acquires the conversion right using speech synthesis and the editing right of the electronic book contents registered into a contents management device in the portal site by a publisher using a terminal device. The electronic book contents is subjected to the speech synthesis conversion to produce an audio book. The speech synthesis editor corrects misread parts and wrong intonation parts in the produced audio book to be registered in the contents management device as the audio book. The publisher utilizes the terminal device to subject the audio book registered in the contents management device to approval work and notifies the result thereof to the contents management device. When the publisher permits registration of the audio book as goods, the contents management device issues a license key for the audio book and registers the audio book together with the license key as goods. When the audio book is not permitted to be registered as goods, the reason that registration of the audio book is not permitted is notified to the speech synthesis editor.

The audio book registered as goods is purchased under license by the user and is utilized by the user. When the user who has purchased the audio book finds misread part or wrong intonation part in the audio book, the misread part or wrong intonation part is transmitted to the contents management device as a correction request. The contents management device transmits the correction request to the speech synthesis editing user who produces the audio book. The speech synthesis editor who has received the correction request judges whether the correction request is proper or not and when it is proper, the editor corrects the audio book on the basis of the correction request. The corrected audio book is uploaded into the contents management device again and is subjected to the approval work by the publisher to be registered as goods. At this time, the version of the audio book is updated in order to discriminate it from the uncorrected audio book. It is a matter of course that a license key for the audio book is also issued in response to the updated version.

Further, since the audio book having the updated version is registered as new goods, the license key for the uncorrected audio book cannot be used. Accordingly, the user who participated in editing by transmitting the correction request is given points in accordance with the content of the correction request and when the points exceed a fixed threshold, the uncorrected license key can be changed to the corrected one. In addition, the user who presents an excellent correction request can be authorized to be changed to the corrected (new) license key irrespective of the points.

As described above, the user who purchased the audio book can also participate in the editing and correction work of the audio book positively and the audio book with higher quality can be produced.

Further, in the embodiment, in order to solve the above problems, a monitor (hereinafter referred to as a check monitor) who points out parts required to be corrected in the contents for which the production processing of the audio book or the pronunciation symbol text is completed can be registered. The check monitor has the privilege capable of listening before the completed audio book or pronunciation symbol text is opened to the public as goods. The check monitor can get the audio book or pronunciation symbol text for listening free or for pay. The foregoing is the outline of the embodiment.

The embodiment is now described concretely with reference to the accompanying drawings.

In the embodiment, the digital contents version management system of user participation type is provided. The digital contents version management system of user participation type has the function of serving as the portal site.

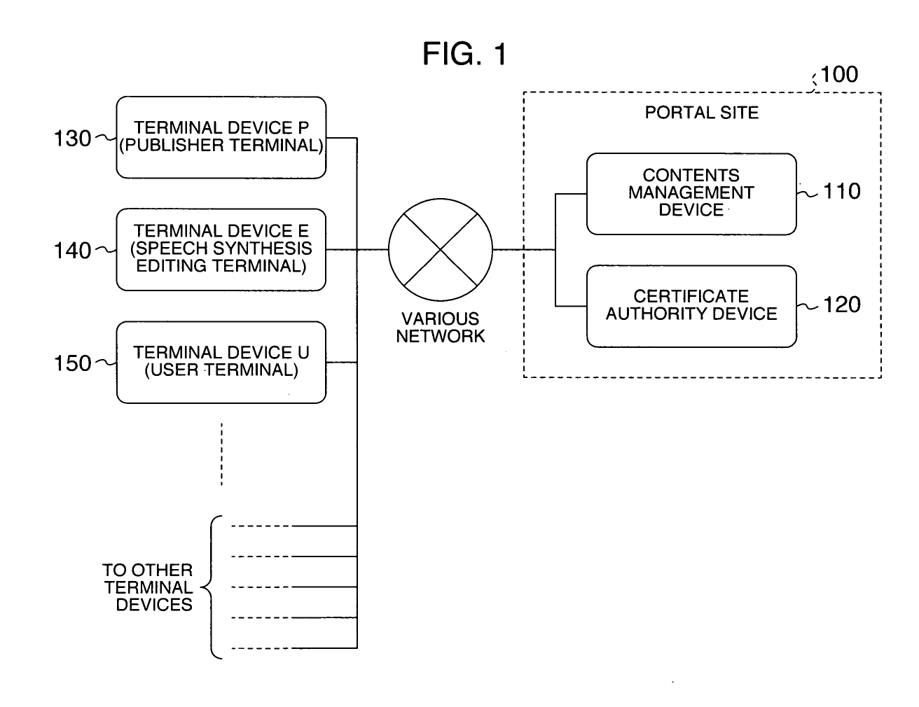

FIG. 1 is a schematic diagram illustrating the digital contents version management system of the embodiment. As shown in FIG. 1, the digital contents version management system of the embodiment includes a contents management device 110, a certificate authority device 120, a terminal device P 130, a terminal device E 140 and a terminal device U 150.

The contents management device 110 is a center device constituting the portal site 100. The contents management device 110 performs management of publishers, speech synthesis editing users and general users, delivery, preservation, permission of editing and sales management of contents responsive to requests from various terminal devices, management of licenses (issue of keys and giving of keys to goods), management of correction requests, estimation of users and management of points for users. The contents management device 110 updates the version of produced or corrected contents in response to the result of approval for permission of opening to the public from the terminal device P 130 and allows the contents to be transmitted to be opened to the public.

The certificate authority device 120 performs the duties of the certificate authority in the portal site 100. The certificate authority device 120 manages digital certifications for the respective users. The digital certification contains a public key. The certificate authority device 120 is based on the Public Key Infrastructure (PKI). Further, the certificate authority device 120 can be replaced by the certificate authority (CA) established independent of the portal site 100.

The terminal device P 130 (publisher terminal) is utilized by a publisher and transmits information instructing to make contents (pronunciation symbol text data and speech data) be opened to the public or not to the contents management device 110 through a network by means of a communication device to control opening of the contents to the public in the contents management device 110. The terminal device P 130 may be any terminal device as far as it is a terminal device such as one of a personal computer (PC), a personal digital assistant (PDA), a tablet for a personal computer and the like. Further, the terminal device can be utilized off-line.

The terminal device E 140 (speech synthesis editing terminal) is utilized by an editor who performs the speech synthesis and may be any terminal device as far as it is a terminal device such as one of a personal computer, a personal digital assistant, a tablet for a personal computer and the like. Further, the terminal device can be utilized off-line. The terminal device E 140 requests the right to edit the contents in the contents management device 110 to the contents management device 110 and edits the contents in accordance with the user's instruction on the basis of the license key concerning the editing right given from the contents management device 110. The terminal device E 140 up-loads the corrected contents into the contents management device 110.

The terminal device U 150 (user terminal) is utilized by a general user and may be any terminal device as far as it is a terminal device such as one of a personal computer, a personal digital assistant, a tablet for a personal computer and the like. Further, the terminal device can be utilized off-line. The terminal device U 150 may have the same function as that of the terminal device E 140. The terminal device U 150 transmits to the contents management device 110 information (hereinafter referred to as correction request) for requesting or instructing the contents management device 110 to correct points to be corrected in the contents which is allowed to be transmitted by the contents management device 110.

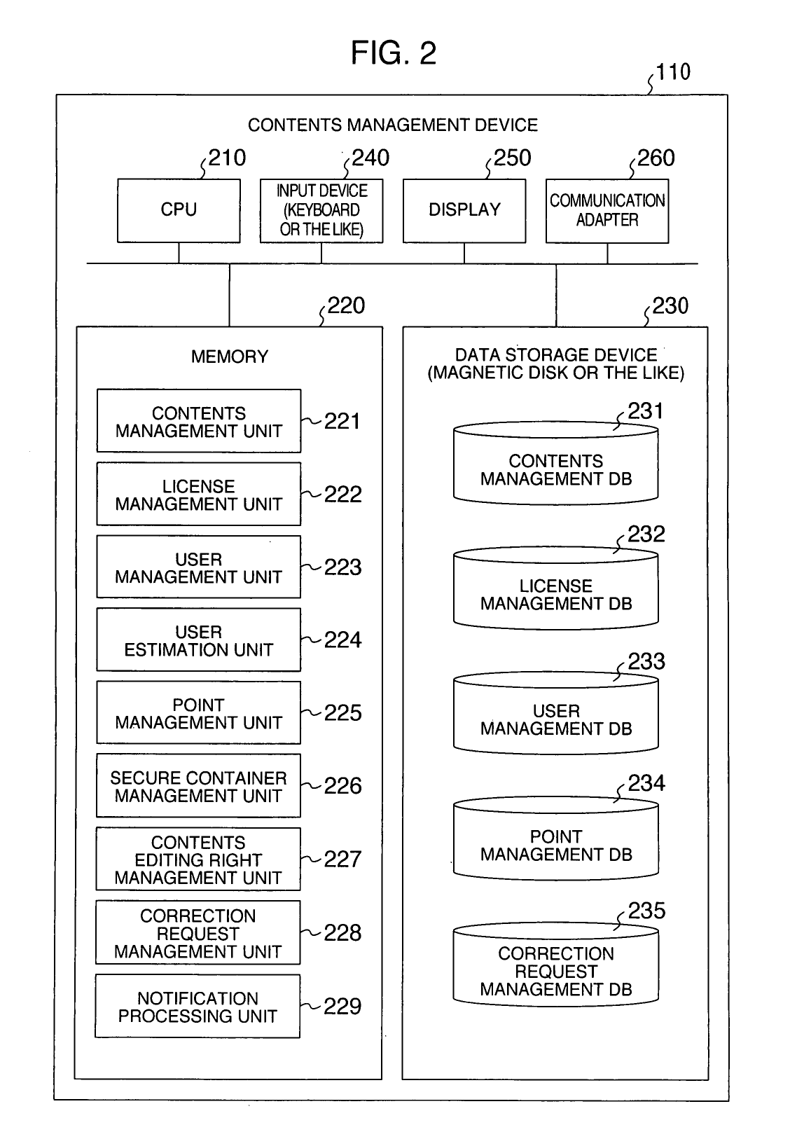

FIG. 2 is a schematic diagram illustrating the contents management device 110 of the embodiment. As shown in FIG. 2, the contents management device 110 of the embodiment includes a central processing unit (CPU) 210, a memory 220, a data storage device 230, an input unit (keyboard or the like) 240, a display 250 and a communication adapter 260.

The CPU 210 is a controller for controlling operation of the whole contents management device 110 and executing programs loaded into the memory 220. The memory 220 is a storage device in which various processing programs and data for controlling operation of the contents management device 110 are loaded. The data storage device 230 is a storage device in which the various processing programs and various digital contents are stored. The input device (keyboard or the like) 240 is to input operation instructions and the like to the contents management device 110. The communication adapter 260 is to communicate with other devices.

The memory 220 of the contents management device 110 includes a contents management unit 221, a license management unit 222, a user management unit 223, a user estimation unit 224, a point management unit 225, a secure container management unit 226, a contents editing right management unit 227, a correction request management unit 228 and a notification processing unit 229.

The contents management unit 221 performs purchase processing at the time that the user purchases the contents, management processing of the contents (audio book and pronunciation symbol text for producing the audio book) edited by the speech synthesis editor and processing for reflecting the result of approval work performed by the publisher in the contents and stores its processing result into a contents management database (DB) 231.

The license management unit 222 issues a license for the contents managed by the contents management unit 221 and stores it in a license management database (DB) 232. The license management unit 222 makes inquiries to the contents management unit 221 even when the version of the license is updated. The license contains (1) a down-loading license indicating whether the user of each terminal device has the right to down-load the contents from the contents management device 110 and (2) a terminal-side utilization license indicating whether the user of each terminal device can utilize the contents at each terminal.

The license management database 232 stores user identifiers (ID) for identifying the users, contents identifiers (ID) for identifying contents, license key numbers 1604, terms of validity of licenses and kinds of licenses in a corresponding manner to one another. The kind of license is information indicating how to utilize the contents and contains, for example, reproduction, editing, deletion, copy and the like. The kind of license may indicate whether the license is the down-loading license or the terminal-side utilization license. For example, when the kind of the license is “down-loading”, the license is the down-loading license and otherwise it is the terminal-side utilization license. Hereinafter, the down-loading license and the terminal-side utilization license are called “license” without distinction unless otherwise specified. A point management table 1600 can be also used as the license management database 232.

The contents management device 110 transmits the terminal-side utilization license to the terminal device. A contents reproduction unit of the terminal device controls whether reproduction, editing or copy of the contents is made or not in accordance with the kind of the received terminal-side utilization license.

Further, when the contents management device 110 divides the contents into sections or scenes to be stored as a plurality of partial data, the contents management device 110 may store identification information of each partial data together therewith. In this case, since the contents management device 110 can receive selection of the partial data for the section or the like from the terminal device E 140 and issue the license for each partial data, the probability that a plurality of users issue editing requests to the same contents simultaneously is reduced.

The user management unit 223 manages the users participating in the portal site. The user management unit 223 makes management for each user, so that duties can be set for each user. There are four kinds of users including general users, editor users, publisher users and monitor users. Further, data used at the time that the general users, the editor users and the monitoring users are estimated is also processed in the user management unit 223 to be stored in a user management database (DB) 233 as estimation data. The pre-registration system is established for the editor users and the editor users cannot be registered through the network like general users. The monitor user is to examine correction requests to be issued from the general user beforehand and point out the correction to the editor user before completed as goods.

The user estimation unit 224 processes the result of the publisher user's estimation for general users, monitor users and editor users. Detailed description thereof will be made with reference to the flow chart of FIG. 17.

The point management unit 225 stores the points held by the users into a point management database (DB) 234 to be managed. The user can get points when the user makes a correction request or comment on certain contents and the editor of the contents judges that the correction request or the comment is useful and valuable.

The contents editing right management unit 227 receives a request from a person who wishes to edit contents and judges whether the editing right of the contents desired by the person is not exercised by anybody. When it is exercised, the contents editing right management unit 227 makes a response to the effect that the editing right cannot be not transferred to the person who wishes to edit the contents. When it is not exercised by anybody, the editing right is transferred to the person. At this time, the ratio of the contents to all the contents (the ratio in case where all the contents is 100) is also presented to the person who wishes to edit the contents. The ratio is utilized when an editing charge to the editor whom the editing right is transferred is calculated. For example, when the ratio of the editing right is 20 percent in case where the total editing charge is 100 yen, the editor can get 20 yen as the editing charge. When the editor makes an application for the editing right, the editor can be notified how much the editing charge of the contents is.

The correction request management unit 228 manages correction requests and comments made by the user in a correction request management database (DB) 235. The correction request management unit 228 has the function of deciding an editor to which a correction request issued to certain contents is sent. Further, the correction request management unit 228 has the function of giving points to the correction request or comment recognized to be useful by the editor.

The notification processing unit 229 prepares transmission data to be sent from the contents management unit 110 to the terminal units P, E and U and sends it to the respective terminal units.

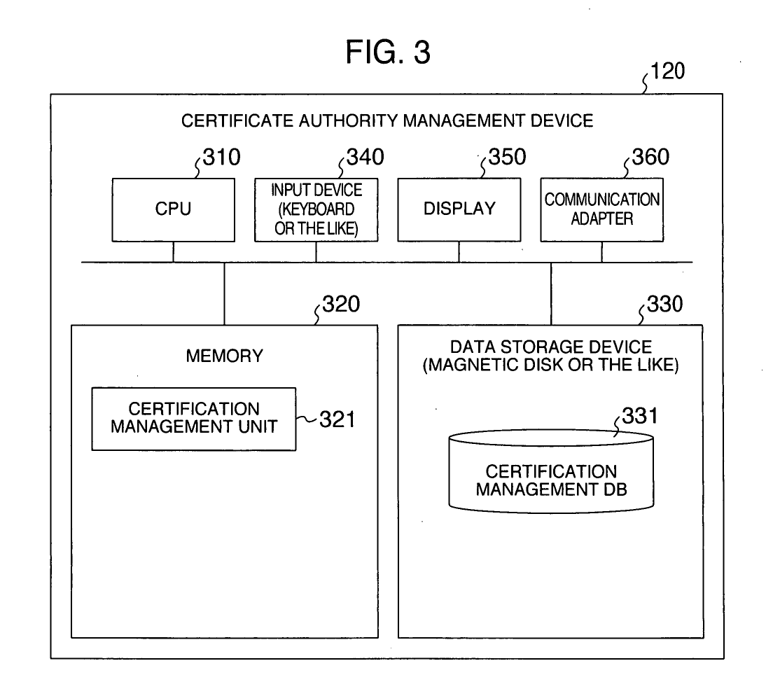

FIG. 3 is a schematic diagram illustrating the certificate authority management device 120 of the embodiment. As shown in FIG. 3, the certificate authority management device 120 of the embodiment includes a central processing unit (CPU) 310, a memory 320, a data storage device 330, an input device (keyboard or the like) 340, a display 350 and a communication adapter 360.

The CPU 310 is a controller for controlling operation of the whole certificate authority management device 120. The memory 320 is a storage device in which various processing programs and data for controlling operation of the certificate authority management device 120 are loaded. The data storage device 330 is a storage device in which the various processing programs and various digital contents are stored. The input device (keyboard or the like) 340 is to input operation instructions to the certificate authority management device 120. The communication adapter 360 is to communicate with other devices.

A certification management unit 321 manages certifications. Data of the certifications are managed in a certification management database (DB) 331. Management of the certifications is usually made by the authorized site named the certificate authority (CA), although it may be made by a corporation itself. In this specification, there is supposed a model which uses the certificate authority capable of issuing certifications on its own account while taking an external certificate authority into consideration.

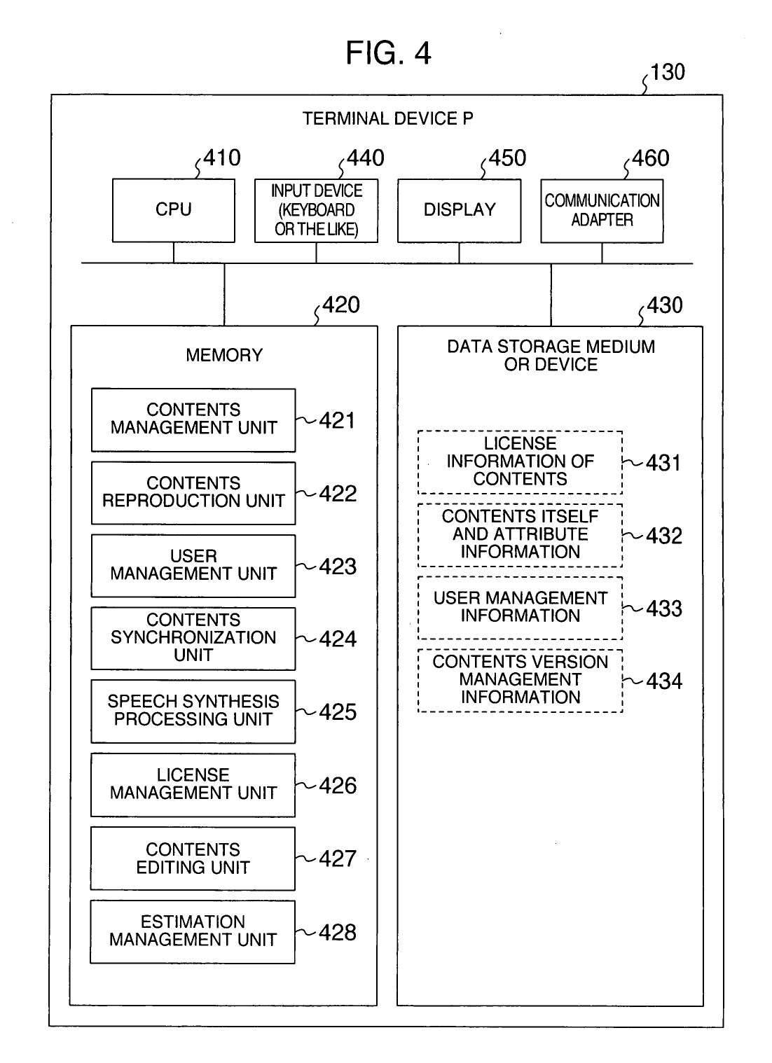

FIG. 4 is a schematic diagram illustrating the terminal device P 130 of the embodiment. As shown in FIG. 4, the terminal device P 130 of the embodiment includes a central processing unit (CPU) 410, a memory 420, a data storage device 430, an input device (keyboard or the like), a display 450 and a communication adapter 460. A contents management unit 421 manages contents to be transmitted to the contents management device 110 and prices thereof. Data is managed as contents itself and attribute information thereof. A contents reproduction unit 422 performs reproduction processing in order to perform approval and correction of contents.

A user management unit 423 manages users who can operate the terminal device P 130. User data is managed as user management information 433. A contents synchronization unit 424 synchronizes contents itself and attribute information thereof such as version and license with registration of the contents into the contents management device 110. A speech synthesis processing unit 425 performs processing for reproducing pronunciation symbol text managed by the contents management device 110.

A license management unit 426 issues licenses of the contents managed by the contents management unit 421 and manages the issued licenses in relation to the contents. License information is stored in the data storage medium or device 430 as contents version management information 434. The license management unit 426 can manage license for each version of the contents. It does not matter even if processing itself of the license management unit 426 is performed as part of processing of the contents management unit 421.

A contents editing unit 427 performs correction and approval of contents. An estimation management unit 428 estimates the users (users of the terminal device U 150) participating in the portal site 100 and the speech synthesis editors (user of the terminal device E 140). The estimation management unit 428 gets history of correction requests from the correction request management database 235 of the contents management device 110 within the portal site and reduces the estimation of persons whose correction requests or comments have irresponsible and vague contents and indication. The speech synthesis editors are also subjected to the same estimation. The measuring rule of the estimation utilizes quality and treatment for comment.

When the estimation is lowered, a value of points acquired by user's correction request is reduced and the threshold thereof is increased due to update of the version, so that the merit obtained by updating the version is lessened even if a correction request is presented. The speech synthesis editor having increased correction requests is not also permitted to make an application for editing from next time according to assessment.

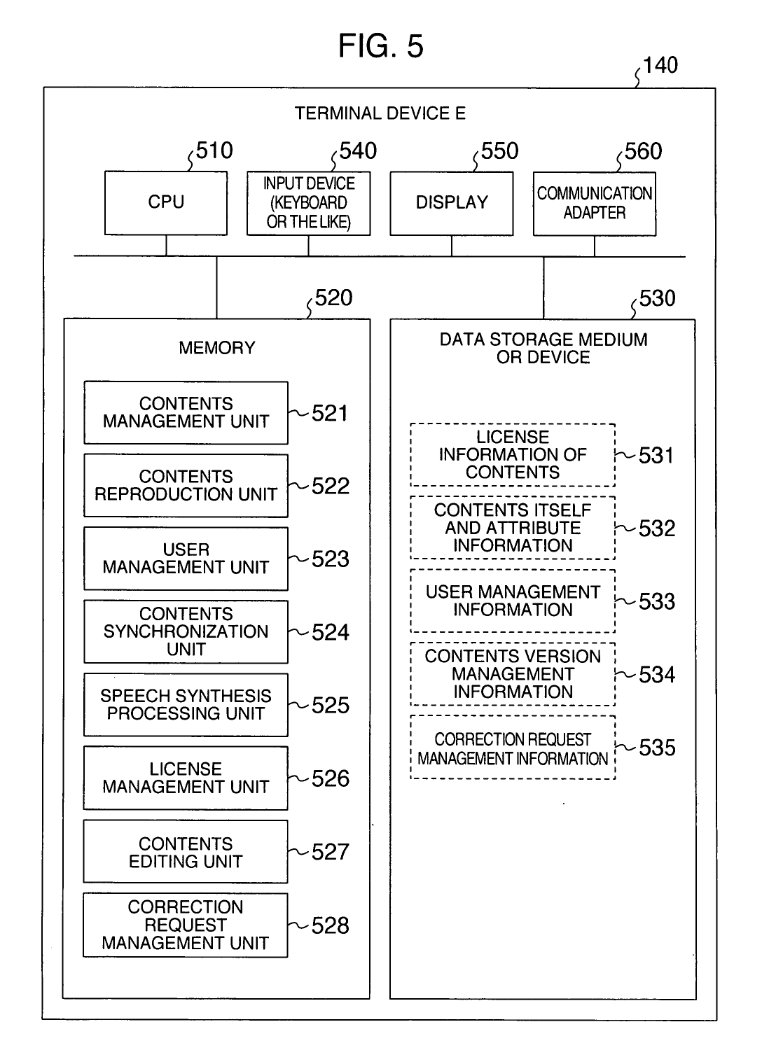

FIG. 5 is a schematic diagram illustrating the terminal device E 140 of the embodiment. As shown in FIG. 5, the terminal device E 140 of the embodiment includes a central processing unit (CPU) 510, a memory 520, a data storage device 530, an input device (keyboard or the like) 540, a display 550 and a communication adapter 560.

A contents management unit 521 manages contents to be transmitted to the contents management device 110 and prices thereof. Data is managed as contents itself and attribute information 532 thereof.

A contents reproduction unit 522 reproduces contents. A user management unit 523 manages users who can operate the terminal device E 140. User data is managed as user management information 533.

A contents synchronization unit 524 synchronizes contents itself and attribute information thereof such as version and license with registration of the contents into the contents management device 110. Version information is managed as contents version management information 534.

A speech synthesis processing unit 525 performs processing for reproducing pronunciation symbol text managed by the contents management device 110.

A license management unit 526 manages licenses of the contents managed by the contents management unit 521. The license information is stored in the data storage medium or device 530 as license information 531 of the contents. The license management unit 526 can manage licenses for each version of the contents. It does not matter even if processing itself of the license management unit 526 is performed as part of processing of the contents management unit 521.

A contents editing unit 527 performs editing and correction processing of the contents. The contents editing unit 527 performs editing processing while the speech synthesis processing unit 525 is utilized to make reproduction by the speech synthesis of the contents.

A correction request management unit 528 manages correction requests obtained from the user (user of the terminal device U 150) participating in the portal site 100. The correction requests are transmitted from the contents management device 110. The transmitted correction requests are stored in the data storage medium or device 530 as correction request management information 535.

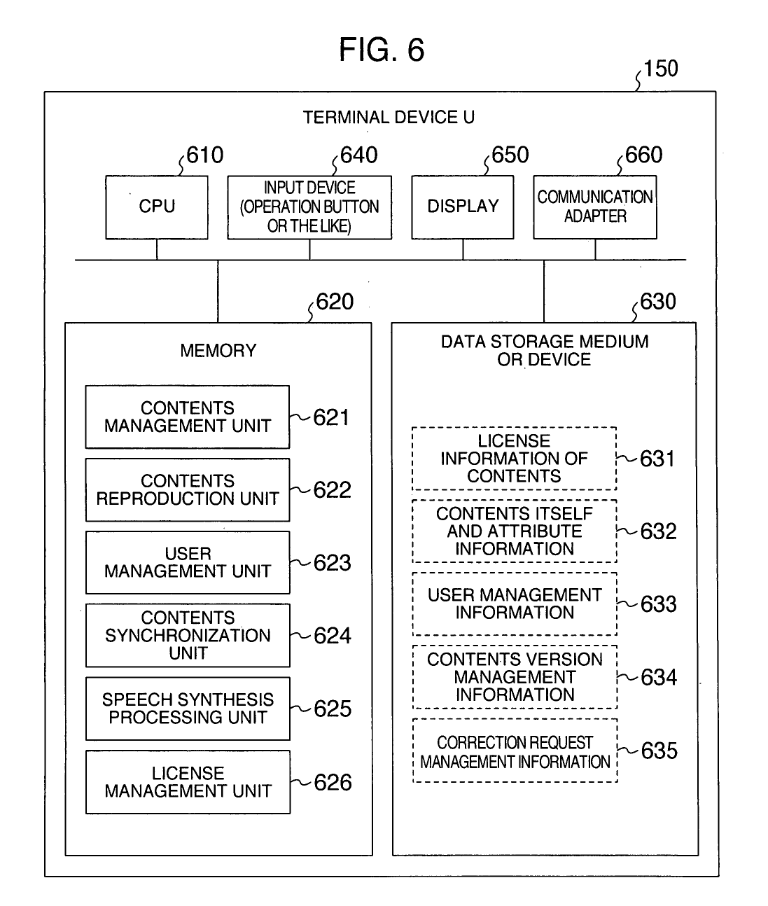

FIG. 6 is a schematic diagram illustrating the terminal device U 150 of the embodiment. As shown in FIG. 6, the terminal device U 150 of embodiment includes a central processing unit (CPU) 610, a memory 620, a data storage device 630, an input device (keyboard or the like) 640, a display 650 and a communication adapter 660.

A contents management unit 621 manages contents purchased from the contents management device 110. Data is managed as contents itself and attribute information 632.

A contents reproduction unit 622 reproduces the purchased contents. A user management unit 623 manages users who can operate the terminal device U 150. User data is managed as user management information 633.

A contents synchronization unit 624 synchronizes contents itself and attribute information thereof such as version and license with down-loading of the contents from the contents management device 110. The version information is managed as contents version management information 634. A speech synthesis processing unit 625 performs processing for reproducing pronunciation symbol text managed by the contents management device 110.

A license management unit 626 manages licenses of the contents managed by the contents management unit 621. The license information is stored in the data storage medium or device 630 as contents version management information 634. The license management unit 626 can manage licenses for each version of the contents. It does not matter even if processing itself of the license management unit 626 is performed as part of processing of the contents management unit 621.

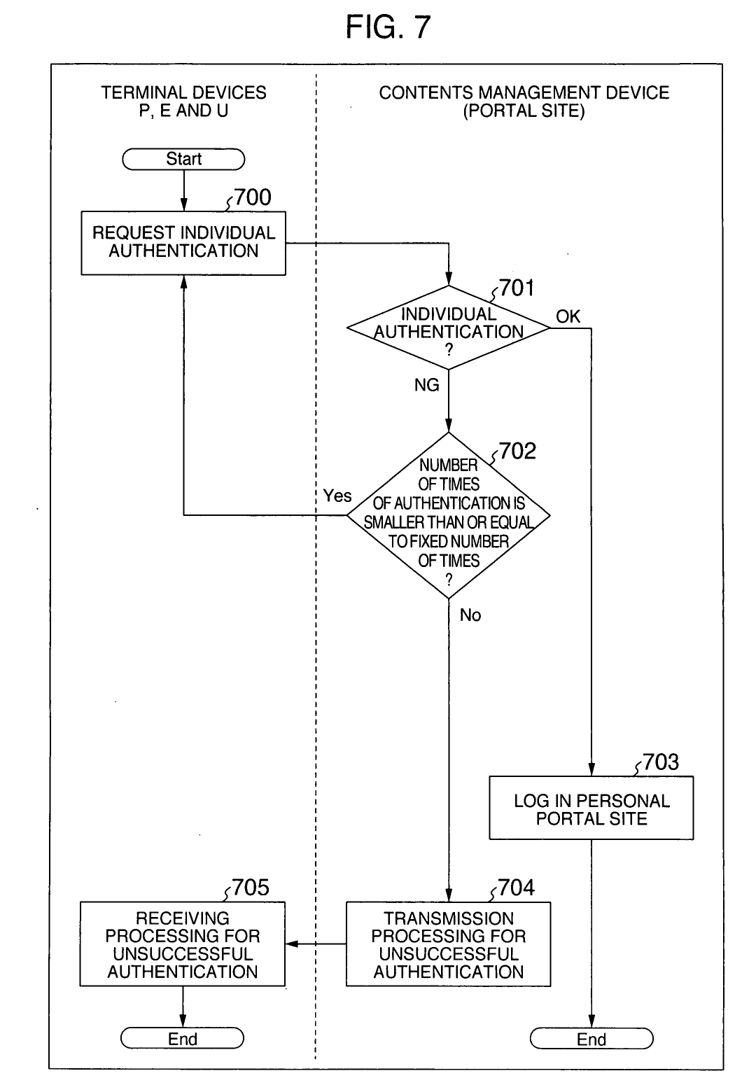

FIG. 7 is a flow chart showing a processing procedure of individual authentication among the contents management device 110, the terminal device P 130, the terminal device E 140 and the terminal device U 150 of the embodiment. When each of the terminal device P 130, the terminal device E 140 and the terminal device U 150 issues a request to the contents management device 110 within the portal site 100, the user is necessarily subjected to individual authentication using user ID and password of the user.

In step 700, each of the terminal device P 130, the terminal device E 140 and the terminal device U 150 makes the user input the user ID and the password and transmits an individual authentication processing request to the contents management device 110 using the inputted data. In step 701, the user ID and the password transmitted from each of the terminals are used to perform individual authentication. If the authentication is successful, the processing proceeds to step 703 and if it is unsuccessful, the processing proceeds to step 702. In step 702, it is judged whether the number of times of authentication is smaller than or equal to a fixed number of times. This processing is performed to prevent illegal authentication from being performed by producing ID and password mechanically. If the number of times of authentication is smaller than or equal to the fixed number of times, the processing is returned to step 700, in which the request processing of the user ID and the password is performed.

On the other hand, when the number of times of authentication exceeds the fixed number of times, the authentication is unsuccessful and the processing proceeds to step 704. In step 703, since the authentication is successful, the user logs in a personal portal site corresponding to the user ID by means of the terminal device, so that a personal portal picture is displayed in the terminal device. In step 704, notification to the effect that the authentication is unsuccessful is transmitted to the terminal device. In step 705, the notification of the unsuccessful authentication transmitted in step 704 is received and the processing is ended.

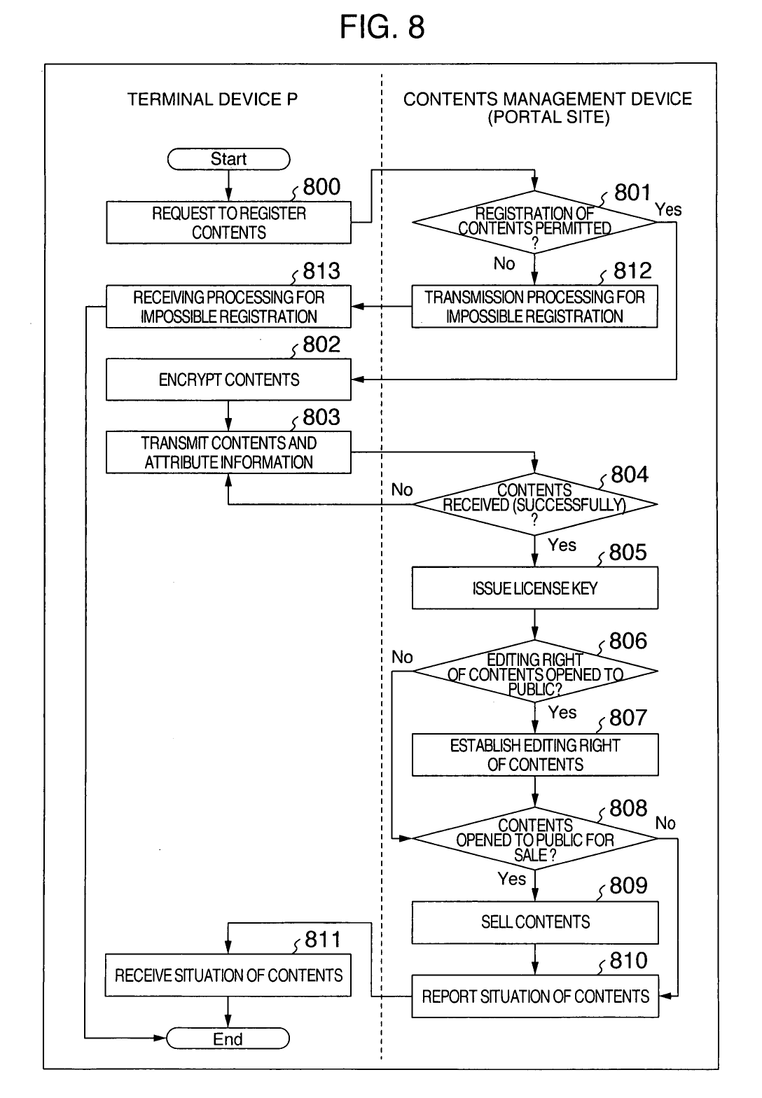

FIG. 8 is a flow chart showing a processing procedure of registering the contents itself and attribute information thereof into the contents management device 110 between the contents management device 110 and the terminal device P 130 of the embodiment. In the flow charts shown in FIGS. 8 to 14, the individual authentication using the user ID and the password is premised. The individual authentication is performed as shown in FIG. 7.

In step 800, a request of registering the contents managed in the terminal device P 130 is transmitted to the contents management device 110. In step 801, it is judged whether the contents requested to be registered can be registered or not and if the registration is possible, the processing proceeds to step 802. If it is impossible due to, for example, maintenance or duplicate registration, the registration is not permitted and the processing proceeds to step 812, in which information to the effect that the registration is impossible is transmitted to the terminal device P 130. In step 813, the information for impossible registration transmitted in step 812 is received and displayed in a display screen of the terminal device P 130.

In step 802, the contents registered in the terminal device P 130 is encrypted. In step 803, the contents encrypted in step 802 and attribute information thereof are transmitted to the contents management device 110. In step 804, the contents and the attribute information thereof transmitted in step 803 are received by the contents management device 110 and when the reception is successful, the processing proceeds to step 805. When the reception is unsuccessful, a retransmission request is transmitted to the terminal device P 130 and the transmission processing is made again. In step 805, a license key is issued and the license key corresponding to the contents to be registered is given. In step 806, it is judged whether the editing right of the contents given the license key is opened to the public or not. When it is judged that the editing right of the contents is opened to the public in step 806, the processing proceeds to step 807. On the other hand, when it is judged that the editing right of the contents is not opened to the public, the processing proceeds to step 808.

In step 807, the editing right of the contents is established. The editing right is to allow processing for producing the pronunciation symbol text using the speech synthesis and can be issued to the editor. The editing right is allowed to be issued to only one editor by exclusive control upon issuance. The unit of editing the contents can be set in part, section, page, paragraph and the like. The unit in which the editing right is exercised can be decided by the publisher or the manager of the portal site. In step 807, the editing right is established to be able to be exercised in the decided unit. In step 808, it is judged whether the contents is opened to the public for sale. When the contents is sold after the pronunciation symbol text is produced using the speech synthesis, the contents is selected not to be opened to the public. When the contents is sold as usual contents, the contents may be opened to the public for sale. When the contents is opened to the public for sale, the processing proceeds to step 809 and when the contents is not opened to the public, the processing proceeds to step 810.

In step 809, the contents is sold. The price of the contents, regulations of the license and the like are established. In step 810, the processing for reporting the situation of the contents for all the registration processing of the contents, for example, the result processed by the contents management device 110 as to whether the license key is issued, whether the editing right of the contents is opened to the public and whether the contents is opened to the public for sale is performed and the situation of the contents is transmitted to the terminal device P 130. In step 811, the terminal device P 130 receives the report of the situation of the contents transmitted by the terminal device P 130 in step 810. The user who is operating the terminal device P 130 can confirm the result received in step 811 in the display screen.

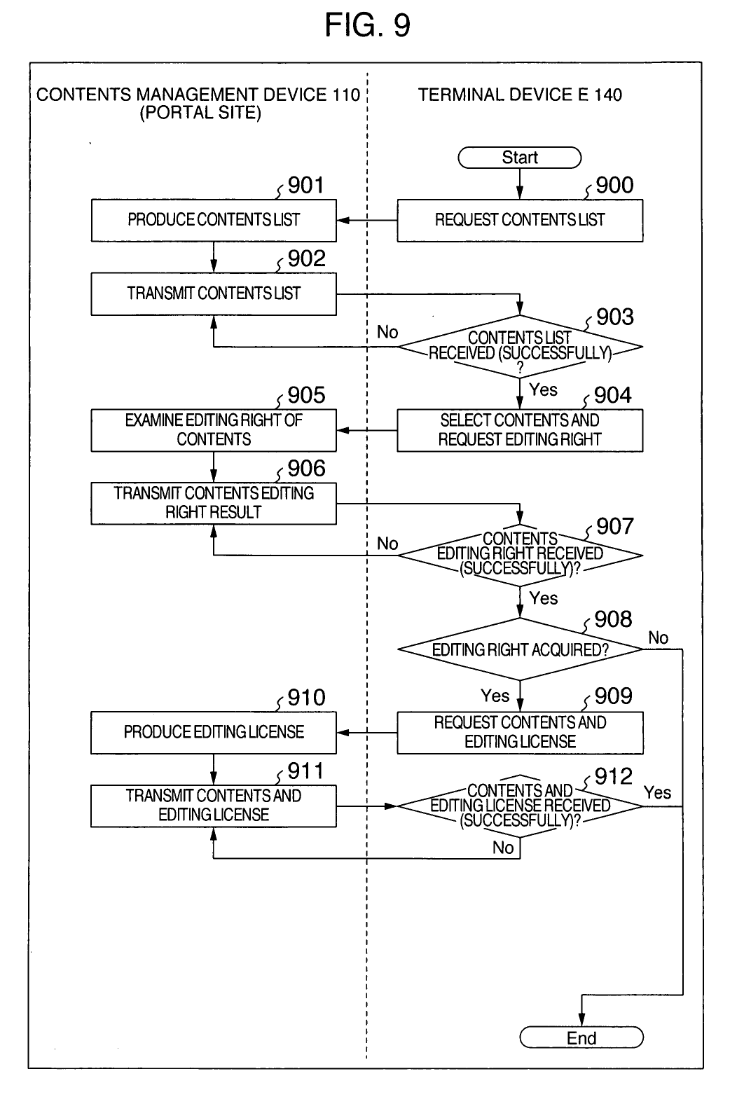

FIG. 9 is a flow chart showing a processing procedure of registering the editing right of the contents itself between the contents management device 110 and the terminal device E 140 of the embodiment.

In step 900, in order to get a list of contents opened to the public currently, the user (editor) utilizing the terminal device E 140 transmits a request of the list of contents to the contents management device 110. In step 901, the contents management device 110 receives the request of the contents list transmitted from the terminal device E 140 and produces the contents list. In step 902, the contents management device 110 transmits information of the produced contents list to the terminal device E 140. The information may be transmitted to the terminal device E 140 as information displayed in the screen or it may be transmitted to the terminal device E 140 as information of mere contents list and be processed into the format displayed in the screen in the terminal device E 140.

Further, the contents may be previously divided into a plurality of partial data and be stored in the storage device in a corresponding manner to the identification information of the contents. In this case, the plurality of partial data can be listed to be displayed in the screen of the terminal device E 140 in a corresponding manner to the identification information of the contents.

In step 903, the terminal device E 140 receives the list of contents. When the reception of the contents list is successful, the processing proceeds to step 904 and when it is unsuccessful, the processing is returned to step 902 and the list of contents is transmitted. In step 904, the contents is selected and the editing right is requested. The terminal device E 140 displays the list of contents in the display and receives an input of selecting the contents which the user wishes to correct.

When the contents is divided into partial data, the terminal device E 140 receives an input of selecting partial data. Further, information of each position to be corrected in the correction request information from the terminal device E 140 can be previously associated with each partial data on the basis of the relation of the length of time of each partial data and the information of each position to be corrected.

The user of the terminal device E 140 selects the contents that the user wishes to edit (the user wishes to speech-synthesize) and transmits information to the effect that the user wishes to correct the contents to the contents management device 110 in order to get the editing right of the contents. In step 905, the contents management device 110 examines whether the editing right requested by the terminal device E 140 can be given or not. That is, when another person already requests the editing right, the request of the editing right is rejected by exclusive control. The examination result in step 905 is transmitted to the terminal device E 140 as the contents editing right result in step 906.

In step 907, when the terminal device E 140 can receive the contents editing right result, the processing proceeds to step 908 and when the reception is unsuccessful, the processing is returned to step 906 and the result is transmitted again. In step 908, whether the terminal device E 140 can acquire the editing right is judged. When the contents editing right can be acquired, the processing proceeds to step 909 and when it cannot be acquired, the editing right registration processing is ended. In step 909, the contents and the editing license are requested to the contents management device 110. In step 910, the editing license of the contents requested by the terminal device E 140 is produced and in step 911 the contents and the produced editing license are transmitted to the terminal device E 140. In step 912, the terminal device E 140 receives the contents and the editing license. When the reception is unsuccessful, the processing is returned to step 911 and the contents and the editing license are transmitted again. When the reception of the contents and the editing license is successful, the editing right registration processing is ended.

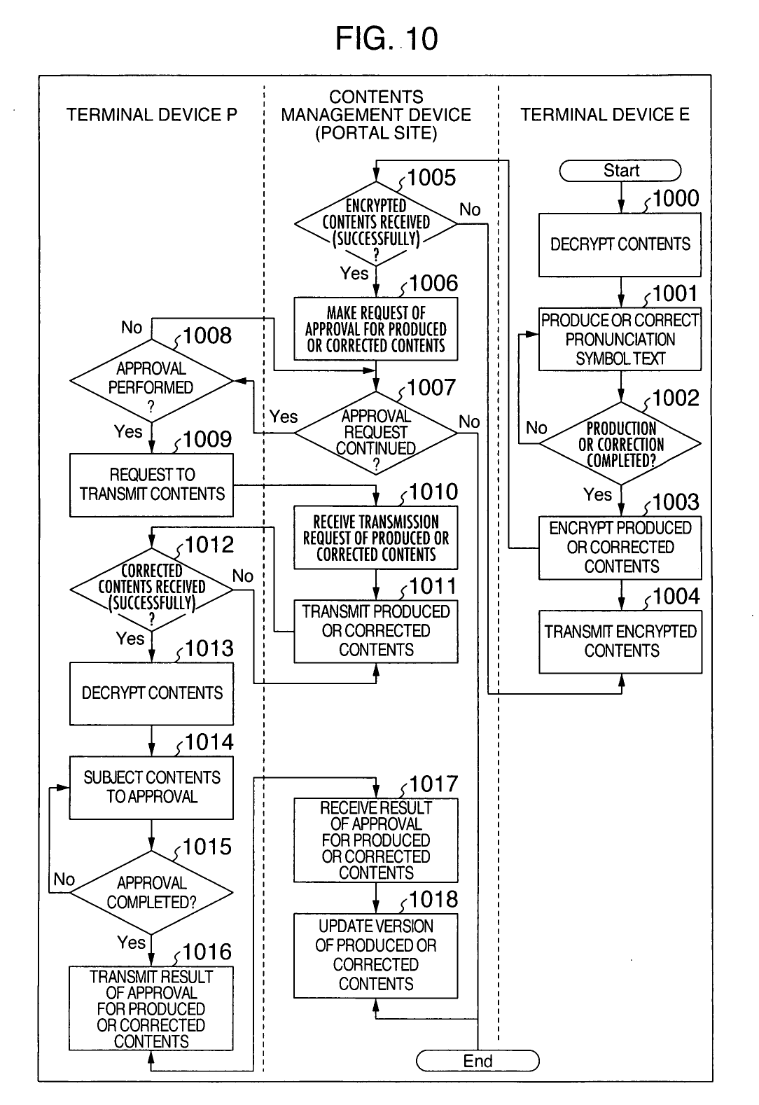

FIG. 10 is a flow chart showing a processing procedure concerning production, correction and approval of the pronunciation symbol text produced from the contents among the contents management device 110, the terminal device P 130 and the terminal device E 140 of the embodiment.

In step 1000, in order to edit the contents transmitted from the contents management device 110 to the terminal device E 140, the encrypted contents is decrypted. In step 1001, production of the pronunciation symbol text or correction of the already produced pronunciation symbol text is performed on the basis of the decrypted contents. In step 1002, when the production or correction is completed, the processing proceeds to step 1003. On the other hand, when it is not completed, the processing is returned to step 1001 and production or correction is continued. In step 1003, the produced or corrected contents is encrypted and in step 1004 the encrypted contents is transmitted to the contents management device 110. In step 1005, the encrypted contents transmitted to the contents management device 110 is received. When the reception is successful, the processing proceeds to step 1006 without opening the corrected contents to the public in the Web at this time. When the reception is unsuccessful, a re-transmission request is made to the terminal device E 140 (processing proceeds to step 1004).

In step 1006, a request of approval for the produced or corrected contents is made to the terminal device P 130. In step 1007, it is judged whether the request is made to the terminal device P 130. When the request is continued, the processing proceeds to step 1008. When the request is not made at this stage, the processing procedure is ended. In step 1008, only when the user utilizing the terminal device P 130 performs the approval processing, the processing proceeds to step 1009. When the approval processing is desired to be performed later, notification is issued to the contents management device 110 (returned to step 1007). In step 1009, when the approval is performed, a transmission request of the contents is transmitted to the contents management device 110. When the contents management device 110 receives the transmission request of the contents (step 1010), the contents management device 110 transmits the contents (step 1011).

In step 1012, the terminal device P 130 receives the contents. In step 1013, the contents is decrypted and in step 1014 the decrypted contents is subjected to approval processing. In step 1015, it is examined whether the approval processing is completed or not. When the approval processing is not completed, the processing proceeds to step 1014. When the approval processing is completed, the processing proceeds to step 1016. In step 1016, the result of approval processing is transmitted. The contents management device 110 receives the result of approval transmitted in step 1016 (step 1017).

In step 1018, the version of the contents is updated on the basis of the result of approval. For example, if opening of the contents to the public is permitted since the result of approval has “no problem”, the contents management device 110 allows the contents to be transmitted and when a license request is received from the terminal device, the contents management device 110 can respond to the request after investigation.

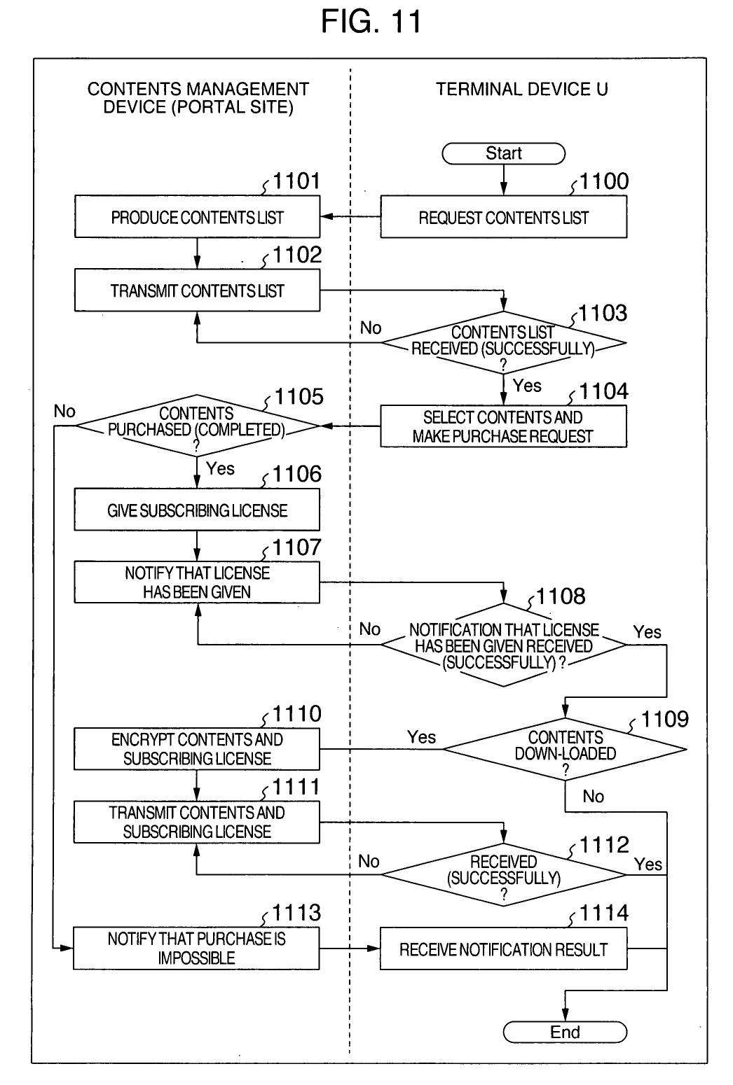

FIG. 11 is a flow chart showing a processing procedure of purchasing the contents between the contents management device 110 and the terminal unit U 150 of the embodiment.

In step 1100, the terminal device U 150 makes a request of the contents list to the contents management device 110. In step 1101, the contents management device 110 produces the contents list in response to the request of the contents list from the terminal device U 150. In step 1102, the contents management device 110 transmits the produced contents list to the terminal device U 150. In step 1103, the terminal device U 150 receives the contents list. When the reception is successful, the processing proceeds to step 1104. When the reception is unsuccessful, the terminal device U 150 makes a request of retransmission of the contents list to the contents management device 110 (returned to step 1102).

In step 1104, the terminal device U 150 selects the contents which the user of the terminal device wishes to purchase from the contents list and makes a purchase request of the contents to the contents management device 110. In step 1105, the contents management device 110 performs purchase processing of the contents selected by the user of the terminal device U 150. When the purchase processing is completed, the processing proceeds to step 1106, although when payment cannot be made by means of the payment method selected by the settlement measure or when the user is to purchase the contents for which the user is not given the purchase right, notification to the effect that the purchase is impossible is transmitted to the user of the terminal device U 150 (step 1113).

The terminal device U 150 receives the notification to the effect that the purchase is impossible and displays it in the screen to notify the user of it (step 1114). In step 1106, a subscribing license is given. When the subscribing license has been given, its result is transmitted to the terminal device U 150 (step 1107). In step 1108, the terminal device U 150 receives the notification to the effect that the license has been given. When the reception is successful, the processing proceeds to step 1109. When the reception is unsuccessful, the terminal device U 150 makes a retransmission request to the contents management device 110 (returned to step 1107). In step 1109, the user of the terminal device U 150 selects whether the contents is down-loaded or not. When the user of the terminal device U 150 requests to down-load the contents after the user purchases the contents, the processing proceeds to step 1110.

On the other hand, when the contents is down-loaded later, the purchase processing is completed. In step 1110, the contents requested to be down-loaded and the subscribing license thereof are encrypted. In step 1111, the contents and the subscribing license encrypted in step 1110 are transmitted to the terminal device U 150. The terminal device U 150 receives the encrypted contents and subscribing license in step 1112. When the reception is successful, the purchase processing is completed and when the reception is unsuccessful, the terminal device U 150 makes a retransmission request to the contents management device 110′ (returned to step 1111).

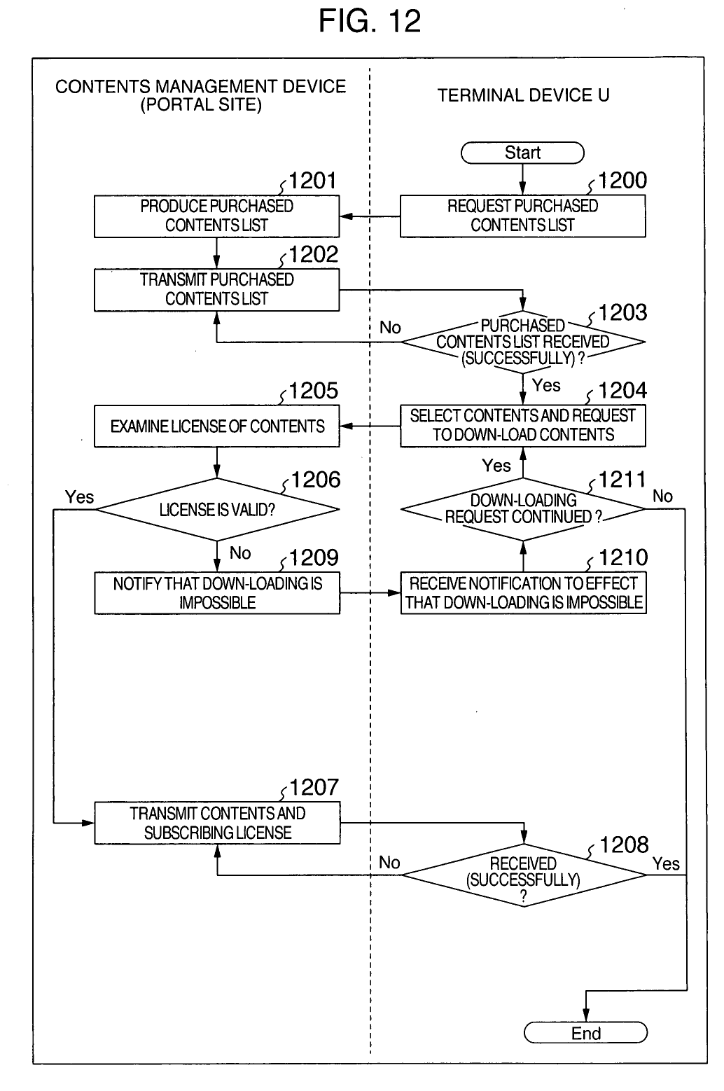

FIG. 12 is a flow chart showing a processing procedure of down-loading the purchased contents between the contents management device 110 and the terminal device U 150 of the embodiment.

As shown in the flow chart of FIG. 11, the license for subscribing to the contents can be purchased at the purchase processing stage. The right (license) for subscribing to the contents is purchased instead of purchasing the contents itself, so that the contents can be down-loaded later. In step 1200, the terminal device U 150 makes a request of the purchased contents list to the contents management device 110. That is, the contents management device 110 manages the license for each user in the license management database 232. In step 1201, the contents management device 110 produces the user's purchased contents list managed in the contents management device 110 and in step 1202 the contents management device 110 transmits the produced contents list to the terminal device U 150.

In step 1203, the terminal device U 150 receives the produced contents list. When the reception is successful, the processing proceeds to step 1204. When the reception is unsuccessful, the terminal device U 150 makes a retransmission request to the contents management device 110 (returned to step 1202). In step 1204, the terminal device U 150 selects the contents to be down-loaded from the purchased contents list and transmits the identification information of the selected contents and the identification information of the user to which the selected contents is down-loaded to the contents management device 110, so that the terminal device U 150 makes a down-loading request to the contents management device 110.

In step 1205, it is examined whether the license of the contents is valid or not by comparing the present time with the term of validity of the license stored in the license management database 232 in response to the request made in step 1204. When the term of validity of the license does not expire, the license is valid. When the license is valid, the processing proceeds to step 1207. When the license is invalid, the processing proceeds to step 1209. In step 1209, the contents management device 110 transmits notification to the effect that down-loading is impossible to the terminal device U 150. The terminal device U 150 decides whether the down-loading request is continued or not on the basis of the received notification to the effect that down-loading is impossible (step 1211). When the down-loading request is continued, the processing proceeds to step 1204. When the down-loading request is not continued, the down-loading processing is ended.

In step 1207, the contents management device 110 transmits the contents and the subscribing (reproduction) license thereof to the terminal device U 150. When the terminal device U 150 (successfully) completes reception of the contents and the subscribing (reproduction) license thereof, the down-loading processing is ended. When the reception is unsuccessful, the processing is returned to step 1207 and retransmission processing is performed.

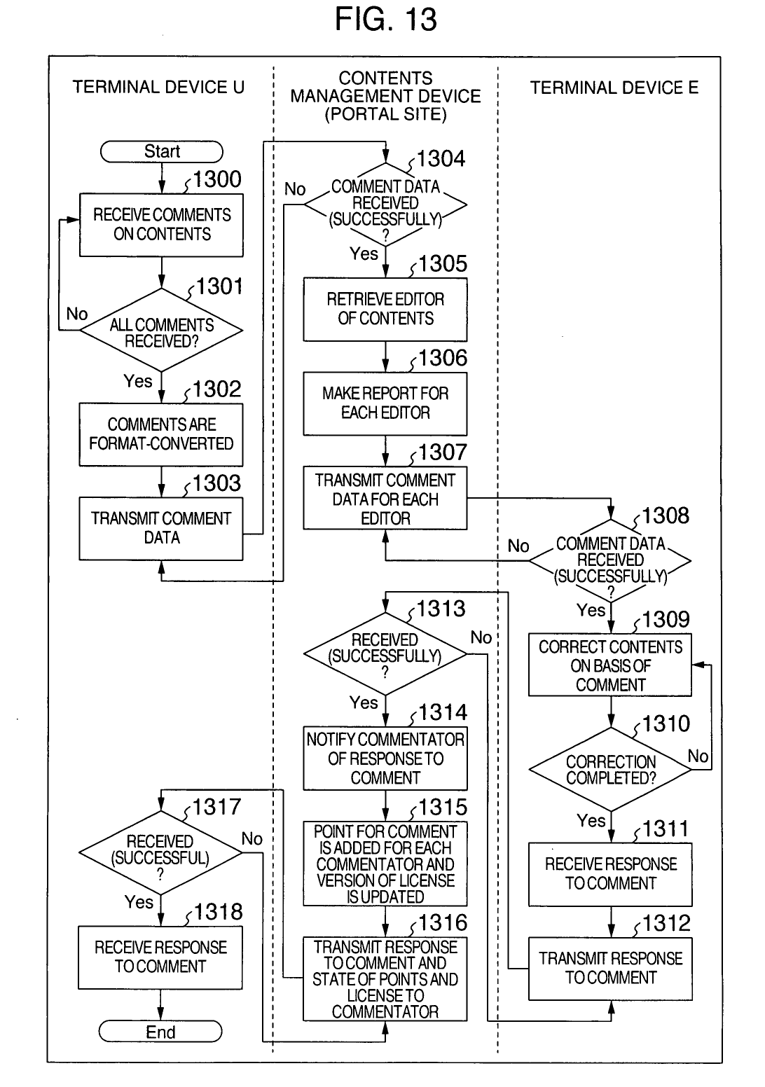

FIG. 13 is a flow chart showing a processing procedure of updating the versions of the comments (correction requests) on the contents and the pronunciation symbol text produced from the contents, the responses thereto and the license among the contents management device 110, the terminal device U 130 and the terminal device E 140 of the embodiment.

In step 1300, the user of the terminal device U 150 receives comments (correction requests) on certain contents and in step 1301 it is judged whether all of the comments (correction requests) are received or not. When the user's inputting of the comments (correction requests) is completed, the processing proceeds to step 1302. When the user's inputting of the comments (correction requests) is not completed, the processing is returned to step 1300. In step 1302, the inputted comments (correction requests) are converted into a comment format so that the editor can understand a position to be corrected in the contents immediately. The position is absolutely designable coordinate information in the target contents such as which letter in which line of which page in the contents (electronic book) or what seconds after the speech synthesized speech file. The conversion into the comment-format allows visually handicapped persons to grasp the position to be corrected immediately. Free comment can be also entered.

In step 1303, the comment-format converted in step 1302 and information for identifying the user who made the comments are transmitted to the contents management device 110 as information requesting to correct the contents or information notifying to correct the contents. The contents management device 110 receives the data of the comment-format transmitted from the terminal device U 150 in step 1304. When the reception is successful, the processing proceeds to step 1305. When the reception is unsuccessful, the contents management device 110 makes a retransmission request to the terminal device U 150 (returned to step 1303). In step 1305, the editor of the contents pointed out by the comment (correction request) is retrieved. Since there are a plurality of editors even for one contents, the editor is specified for each part of comments (correction requests). Even when the editor is specified, the comment-format used in step 1302 is utilized. In step 1306, a report is made for each editor.

In step 1307, the report for each editor produced in step 1306 is transmitted to the terminal device E 140 of the editor. In step 1308, the editor receives the comment data transmitted from the contents management device 110 by means of the terminal device E 140. The comment data contains information concerning a position to be corrected in the contents. When the reception of the comment data is successful, the processing proceeds to step 1309. When the reception is unsuccessful, the terminal device E 140 makes a retransmission request to the contents management device 110 (returned to step 1307). In step 1309, the contents (pronunciation symbol text) is corrected on the basis of the comment data (comment-format) acquired by the editor or the free comment.

In step 1310, when the correction work is completed, the processing proceeds to step 1311. When the correction work is not completed, the correction work is continued in step 1309. In step 1311, the terminal device E 140 receives an editor's response to the comment used to correct the contents in step 1309. In step 1312, the response prepared in step 1311 is transmitted to the contents management device 110. The contents management device 110 receives the response to the comment data from the terminal device E 130 in step 1313. When the reception is successful, the processing proceeds to step 1314. When the reception is unsuccessful, the contents management device 110 makes a retransmission request to the terminal device E 140.

In step 1314, the contents management device 110 notifies the response to the user (commentator/person who makes a correction request or correction requestor) who has issued the comment (correction request) on the basis of the response to the received comment data. In step 1315, point for the comment is added for the correction requestor in accordance with the contents of the response. When the contents of the response indicate that the comment is useful, relatively higher points are given to the correction requestor who presented the comment. Judgment as to whether the comment is useful may be made not only in accordance with the contents of the response received from the terminal device E 140 but also an amount of correction made on the basis of the comment.

When the number of points for the corrected contents at point 1605 of the point management table 1600 corresponding to user ID 1601 of the correction requestor reaches a predetermined number of points that the version of the license can be updated after the point is added, the version of the license of the correction requester for the contents is updated. The point that the version can be updated can be prescribed for each contents or fixed for all contents.

In step 1316, the response to the comment and the states of points and license are notified to the commentator/correction requester. The terminal device U 150 receives the notification of the response to the comment and the states of points and license transmitted to the commentator/correction requester from the comment management device 110 in step 1317. When the reception is successful, the processing proceeds to step 1318. When the reception is unsuccessful, the terminal device U 150 makes a retransmission request to the contents management device 110. In step 1318, the terminal device U 150 receives the response to the comment and the states of points and license. The receiving processing means the processing of displaying on the screen and receiving data obtained by communication means such as electronic mail to be taken in the terminal device U 150.

As described above, the correction requestor who makes the comment judged to be useful in the point addition processing is given the license of the contents to which the comment is made and the version of which is corrected. Accordingly, an incentive to point out improvement of the contents can be given to the correction requester.

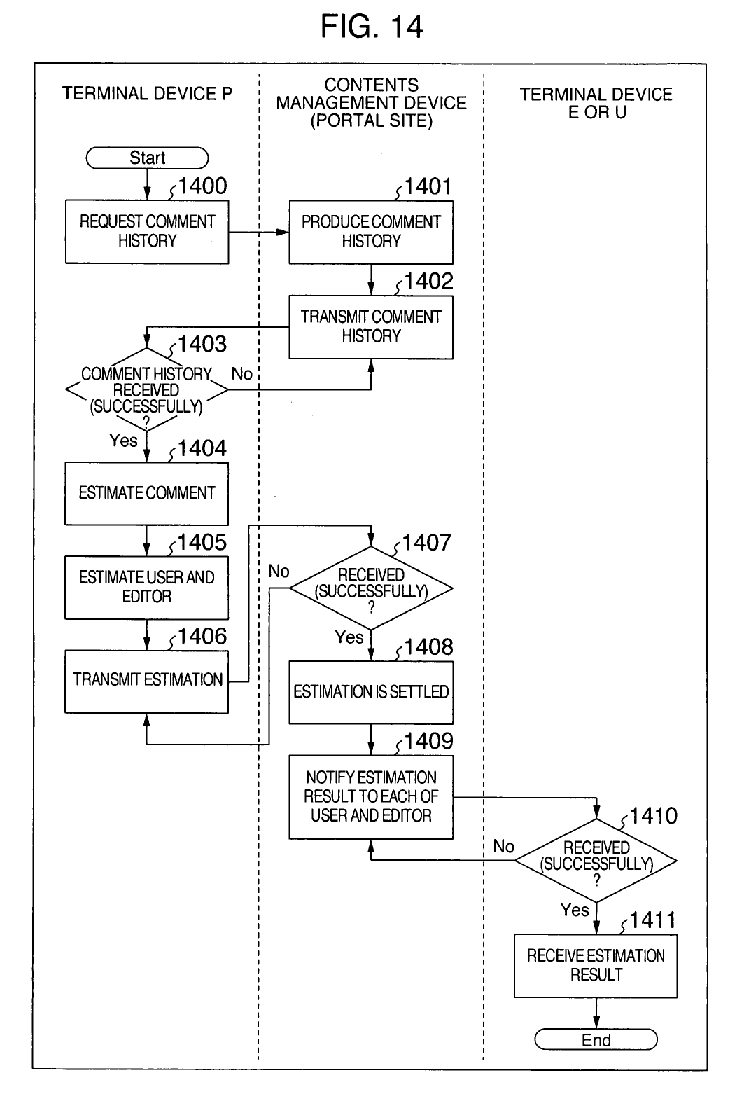

FIG. 14 is a flow chart showing a processing procedure of estimating the user and the editor with regard to the comments (correction requests) among the contents management device 110, the terminal device P 130 and the terminal device E 140 of the embodiment.

In step 1400, the terminal device P 130 requests the comment history to the contents management device 110. The contents management device 110 produces data of the requested comment history in step and transmits the comment history to the terminal device P 130 in step 1402. The terminal device P 130 receives the comment history data transmitted from the contents management device 110 in step 1403. When the reception is successful, the processing proceeds to step 1404. When the reception is unsuccessful, the terminal device P 130 makes a retransmission request to the contents management device 110. In step 1404, the terminal device P 130 estimates the comments on the basis of the comment history. In step 1405, the user and the editor are estimated on the basis of the estimation of the comment to settle estimation for the user and the editor.

In step 1406, the terminal device P 130 transmits the estimation data settled in step 1405 to the contents management device 110. The contents management device 110 receives the estimation data in step 1407. When the reception is successful, the processing proceeds to step 1408. When the reception is unsuccessful, the contents management device 110 makes a retransmission request to the terminal device P 130. In step 1408, estimation is settled for each of the user and the editor on the basis of the estimation data. In step 1409, the result settled in step 1408 is notified to the user and the editor. In step 1410, the terminal device E 140 or the terminal device U 150 receives the notification transmitted in step 1409. When the reception is successful, the processing proceeds to step 1411. When the reception is unsuccessful, a retransmission request is made to the contents management device 110.

In step 1411, the terminal device E 140 or the terminal device U 150 receives the notified estimation result. The contents management device 110 may make addition to the point 1605 of the correction requester or the editor having the higher estimation result than that of other users.

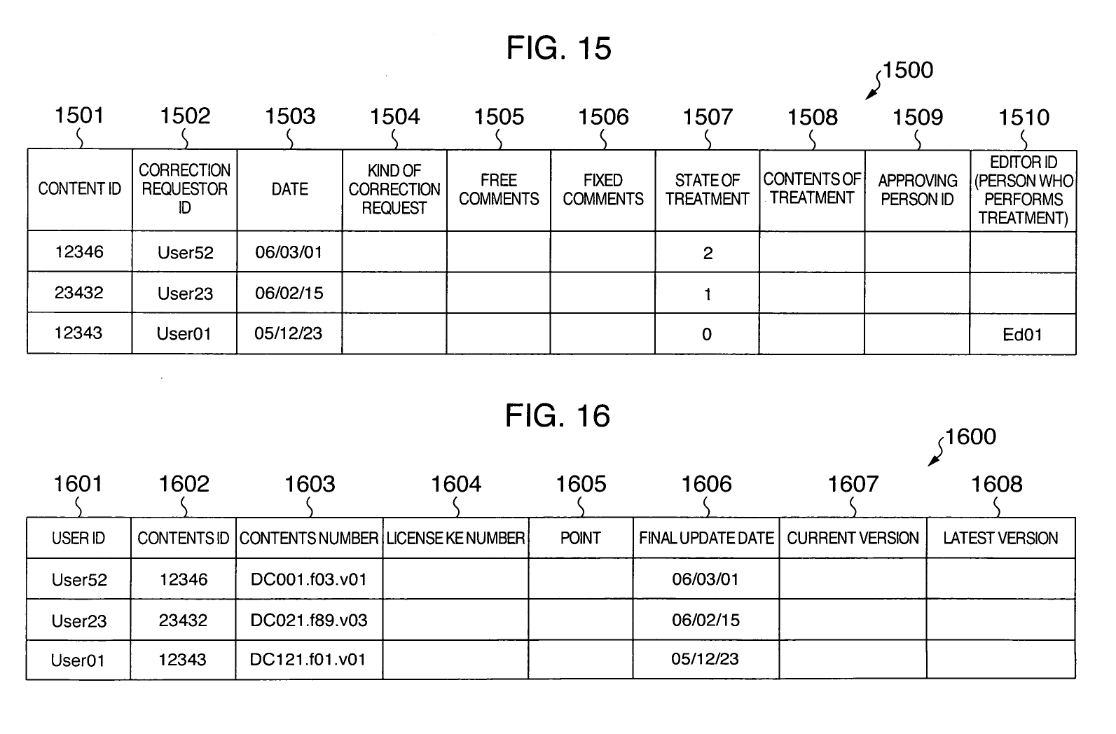

FIG. 15 shows an example of a data table for managing the comments (correction requests) of the embodiment.

The correction request management data table 1500 includes contents ID's 1501, correction requester ID's 1502, date 1503, kinds of correction requests 1504, free comments 1505, fixed comments 1506, states of treatment 1507, contents of treatment 1508, approving person ID's 1509 and editors ID's 1510.

The contents ID 1501 is a number for identifying contents to be sold. The user selects the contents ID to perform purchase of the contents and acquisition of the editing right. The correction requester ID 1502 is an ID for identifying the user who makes a comment (correction request) on the contents identified by the contents ID 1501. The date 1503 shows the date that the comment was made. The kind of correction request 1504 is to prescribe that only free comments are entered or only fixed comments are entered or both comments are entered. Comments can be described in the free comment 1505 freely as text data.

The fixed comment 1506 is the comment based on the comment-format. The state of treatment 1507 shows what treatment is performed for the comment. For example, if any treatment is not performed, “0” indicating that any treatment is not yet performed is entered therein, if correction has been made, “1” indicating that correction has been already made is entered therein, and if any treatment is not required for the comment, “2” indicating that any treatment is not required is entered therein. Free description showing what treatment is performed for the comment is entered in the contents of treatment 1508. The approving person ID 1509 is an ID for identifying the person who judges whether correction made for the comment has a problem or not. The editor ID 1510 is an ID of the editor who makes correction for the comment. The editor identified by the editor ID 1510 is also an editor who edits the content ID. However, the editor identified by the editor ID 1510 is not required to be the same as the editor who edits the content ID.

In step 1006 described above, when the contents management device 110 receives the corrected contents from the terminal device E 140, the contents management device 110 transmits the request of approval for the produced or corrected contents to the terminal device P 130. However, the contents management device 110 may read out the contents having the state of treatment indicating that correction has been already made from the storage device in response to a request from the publisher terminal (terminal device P 130) and transmit the read-out contents to the publisher terminal.

FIG. 16 shows an example of a data table for managing the points acquired by the user of the embodiment.

The point management data table 1600 includes user ID's 1601, contents ID's 1602, contents numbers 1603, license key numbers 1604, points 1605, final update dates 1606, current versions 1607 and latest versions 1608.

The user ID 1601 is to identify the user. The contents ID 1602 is to identify the contents. The contents ID is given to each version of one contents. The contents number 1603 is a name corresponding to the contents ID. Version number or correction number is specified as the contents number 1603. The license number 1604 is issued to the contents ID to be used for subscribing and editing. The point 1605 shows the points held currently by the user having the user ID. The final update date 1606 shows the final date that the point is updated. The current version 1607 shows the version for the contents ID held by the user having the user ID. The latest version 1608 shows the latest version of the target contents ID. The latest version may be omitted since it is managed in the contents management database 231 and the license management database 232 of the contents management device 110.

According to the embodiment, the visually handicapped people can participate in the editing work of the electronic book contents and it can be assisted to promote the participation in social activities of the visually handicapped people. Further, the people who cannot read books although they want to read can be gotten enjoyed reading at the same price as that of healthy normal people.

Moreover, since there can provide a measure for allowing users to participate in preparation of the audio books or the pronunciation symbol text, the preparation cost of the pronunciation symbol text can be suppressed.

It should be further understood by those skilled in the art that although the foregoing description has been made on embodiments of the invention, the invention is not limited thereto and various changes and modifications may be made without departing from the spirit of the invention and the scope of the appended claims.

1. A digital contents version management system including:
a contents management device having a processing unit, a memory and a communication unit to transmit data of pronunciation symbol text constituting basis for reproducing voice by means of speech synthesis;
a first terminal device to transmit a correction request for the pronunciation symbol text data to the contents management device; and
a second terminal device utilized to correct the pronunciation symbol text data to transmit the corrected pronunciation symbol text data to the contents management device;
wherein
the processing unit stores the pronunciation symbol text data and a user having a right to utilize the pronunciation symbol text data into the memory in a corresponding manner to each other; and
the communication unit of the contents management device receives the correction request for the pronunciation symbol text data stored in the memory from the first terminal device;
the processing unit storing, when voice data corrected in accordance with the received correction request is received from the second terminal device, the corrected voice data and information concerning a right to utilize the corrected voice data into the memory in a corresponding manner to a user of the first terminal device.

2. A digital contents version management system according to claim 1, wherein
identification information of the pronunciation symbol text data selected in the first terminal device is received from the first terminal device, and
information concerning a right corresponding to the received identification information of the pronunciation symbol text data and the user of the first terminal device is read out from the memory,
the pronunciation symbol text data corresponding to the received identification information of the pronunciation symbol text data and the read-out information concerning the right being transmitted to the first terminal device.

3. A digital contents version management system according to claim 1, wherein
the processing unit stores the correction request received from the user of the first terminal device and information of a state of treatment as to whether correction for the correction request has been made into the memory, and
the processing unit transmits, when the stored information of the state of treatment indicates that the correction has been made, the corrected pronunciation symbol text data to the contents management device.

4. A digital contents version management system according to claim 3, wherein
the processing unit receives point information concerning estimation of the correction request from the second terminal device, and
when the accumulated number of points of the received point information is larger than or equal to a predetermined value for the user of the first terminal device, the corrected pronunciation symbol text data and the information of the right to utilize the corrected pronunciation symbol text data are stored into the memory in a corresponding manner to identification information of the user of the first terminal device.

5. A digital contents version management system according to claim 1, wherein
the information of the right to utilize the pronunciation symbol text data is a license key concerning a right to correct or reproduce the pronunciation symbol text data, and
when the processing unit of the contents management device receives information to the effect that a terminal device except the second terminal device wishes to correct the pronunciation symbol text data from the terminal device except the second terminal and at the same time a plurality of users do not wish to correct the same pronunciation symbol text data before the processing unit receives information to the effect that the second terminal device wishes to correct the pronunciation symbol text data from the second terminal device, the processing unit transmits the license key concerning the right to correct the pronunciation symbol text data to the second terminal,
the information concerning the utilization right stored in the memory in a corresponding manner to the first terminal device being the license key concerning the right to reproduce the corrected pronunciation symbol text data.

6. A digital contents version management system according to claim 5, wherein
the license key is stored into the memory in a corresponding manner to a kind of how to utilize the contents, the user and the contents.

7. A digital contents version management system according to claim 1, wherein
the processing unit transmits information of a display picture for displaying a list of pronunciation symbol text data stored in the memory and receiving selection of the pronunciation symbol text data corrected by the second terminal device to the second terminal device.

8. A digital contents version management system according to claim 7, wherein
the correction request contains information indicating a position to be corrected in the pronunciation symbol text data to which the correction request is made, and
the processing unit transmits the information indicating the position concerning the correction request and data concerning the correction right for the pronunciation symbol text data selected by the second terminal device.

9. A digital contents version management system according to claim 8, wherein
the processing unit divides the pronunciation symbol text data into a plurality of partial data and stores information of the position to be corrected in each partial data into the memory, and
the processing unit transmits information of a display picture for displaying information of the partial data and receiving selection of the partial data to be corrected by the second terminal device to the second terminal device,
the processing unit transmitting the partial data selected by the second terminal device and having the correction right to the second terminal device.

10. A digital contents version management system according to claim 7, wherein
the processing unit is connected to a publication terminal device for controlling opening of the pronunciation symbol text data to the public through a network by means of the communication device, and
the processing unit transmits, when the processing unit receives the corrected pronunciation symbol text data having the correction right from the second terminal device, information of a display picture in which the received corrected pronunciation symbol text data is not displayed to a user of a terminal device except the second terminal device in response to a display request for the list of the pronunciation symbol text data to the user of a terminal device except the second terminal device,
the processing unit storing, when a request for asking for a license of the corrected pronunciation symbol text data is received from the user of the terminal device except the second terminal device in case where information for permitting opening of the corrected pronunciation symbol text data to the public is received from the contents management device, the license and information concerning a right to reproduce the corrected pronunciation symbol text data in a corresponding manner to each other into the memory.

11. A digital contents version management system according to claim 2, wherein
the information of the right to utilize the pronunciation symbol text data is a license key concerning a right to correct or reproduce the pronunciation symbol text data, and
when the processing unit of the contents management device receives information to the effect that a terminal device except the second terminal device wishes to correct the pronunciation symbol text data from the terminal device except the second terminal and at the same time a plurality of users do not wish to correct the same pronunciation symbol text data before the processing unit receives information to the effect that the second terminal device wishes to correct the pronunciation symbol text data from the second terminal device, the processing unit transmits the license key concerning the right to correct the pronunciation symbol text data to the second terminal,
the information concerning the utilization right stored in the memory in a corresponding manner to the first terminal device being the license key concerning the right to reproduce the corrected pronunciation symbol text data.

12. A digital contents version management system according to claim 3, wherein
the information of the right to utilize the pronunciation symbol text data is a license key concerning a right to correct or reproduce the pronunciation symbol text data, and
when the processing unit of the contents management device receives information to the effect that a terminal device except the second terminal device wishes to correct the pronunciation symbol text data from the terminal device except the second terminal and at the same time a plurality of users do not wish to correct the same pronunciation symbol text data before the processing unit receives information to the effect that the second terminal device wishes to correct the pronunciation symbol text data form the second terminal device, the processing unit transmits the license key concerning the right to correct the pronunciation symbol text data to the second terminal,
the information concerning the utilization right stored in the memory in a corresponding manner to the first terminal device being the license key concerning the right to reproduce the corrected pronunciation symbol text data.

13. A digital contents version management system according to claim 4, wherein
the information of the right to utilize the pronunciation symbol text data is a license key concerning a right to correct or reproduce the pronunciation symbol text data, and
when the processing unit of the contents management device receives information to the effect that a terminal device except the second terminal device wishes to correct the pronunciation symbol text data from the terminal device except the second terminal and at the same time a plurality of users do not wish to correct the same pronunciation symbol text data before the processing unit receives information to the effect that the second terminal device wishes to correct the pronunciation symbol text data from the second terminal device, the processing unit transmits the license key concerning the right to correct the pronunciation symbol text data to the second terminal,
the information concerning the utilization right stored in the memory in a corresponding manner to the first terminal device being the license key concerning the right to reproduce the corrected pronunciation symbol text data.
